(19) United States
(12) Patent Application Publication
(10) Pub. No.: US 2013/0206990 A1
(43) Pub. Date: Aug. 15, 2013

(54) Background Limited Focal Plane Array Assembly

(71) Applicants: Ying Hsu, San Clemente, CA (US); Medhat Azzazy, Laguna Niguel, CA (US); Nim Tea, Cupertino, CA (US)

(72) Inventors: Ying Hsu, San Clemente, CA (US); Medhat Azzazy, Laguna Niguel, CA (US); Nim Tea, Cupertino, CA (US)

(73) Assignee: ISC8 Inc., Costa Mesa, CA (US)

(21) Appl. No.: 13/589,231

(22) Filed: Aug. 20, 2012

Related U.S. Application Data
(60) Provisional application No. 61/526,077, filed on Aug. 22, 2011.

(51) Int. Cl. G01J 5/12

(52) U.S. Cl. CPC G01J 5/12
USPC 250/338.4; 250/349; 250/353

(57) ABSTRACT

The thermoelectric detector comprises an infrared absorber pixel structure supported by two electrically connected beams made of a thermoelectric material. One end of the thermoelectric beam connects to the infrared absorber pixel structure; the other end connects to the substrate. The detector comprises a microlens for collecting and focusing infrared radiation on the detector. Infrared radiation is incident on the infrared absorber pixel structure results in a temperature gradient along the length of the thermoelectric legs, and generating an electrical voltage proportional to the gradient. A low noise SIGe BiCMOS readout integrated circuit is coupled to the detector to provide a background limited detector having improved detectivity.

### CROSS-REFERENCE TO RELATED APPLICATIONS

This application claims the benefit of U.S. Provisional Patent Application No. 61/526,077, filed on Aug. 22, 2011, entitled “Background Limited Focal Plane Array Device Comprising Ultra-Low Noise Readout Integrated Circuit and Thermoelectric Superlattice Focal Plane Array Structure” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of integrated circuits and focal plane array devices. More specifically, the invention relates to a background limited focal plan array device comprising a micro-lens, an ultra-low noise readout integrated circuit (“ROIC”) in cooperation with a thermoelectric superlattice structure focal plane detector array.

2. Description of the Related Art

Industry seeks infrared (IR) sensor technologies with significant improvements in performance and functionality as compared to current long wave IR (LWIR) microbolometer focal plane arrays (FPAs). IR sensors have applications in a number of fields including thermal imaging in lightweight platforms such as micro-UAVs and soldier “Clip-On Thermal Imaging Systems” for use in night vision systems.

An improved uncooled LWIR sensor array is needed that can operate in ambient environments with sensitivity approaching Background Limited Infrared Performance (BLIP), with a fast response time and with multi-spectral capabilities.

Current VOx microbolometer technology used for LWIR detection is a relatively mature technology and despite advances, its performance has reached a plateau. At the same time, sensors utilizing uncooled, background limited infrared performance detectivity have the capacity to achieve performance of many times greater than that of prior art VOx FPAs.

Nonetheless, attaining uncooled BLIP in a detector array is very challenging. To date, IR detectors with nano-engineered materials have provided a major stepping stone to achieving performance improvement. For instance, ISC8 Inc., assignee of the instant application, has shown that the thermoelectric superlattice focal plane array architecture of the invention of FIG. 1a, can achieve an estimated detectivity (D*) value of about 2.4×109 cm-√Hz/W.

Despite successful advances, current microbolometer technology requires a challenging, order-of-magnitude improvement in order to reach performance levels of, for instance, those of cooled HgCdTe photon detectors. IR detectors built using nano-engineered materials provide a solution to achieving these needed performance improvements.

In addition to enhancing detector performance and functionality, nano-engineered sensors offer the ability to dramatically miniaturize IR systems. That is, nano-engineered IR detectors enable the development of a multi-spectral, low power camera in the form factor of a chip, or an “IR Camera-In-A-Chip”.

In certain applications, over 60% of the power in an IR camera is consumed by post-processing electronics that perform FPA output processing functions such as analog-to-digital conversion, non-uniformity correction and fine temperature compensation. Further, over 80% of the camera's mass and volume may be due to post-readout electronics assembly and optics.

The device of the invention enables the design of an IR detector using nano-engineered materials that can operate in a thermo-voltaic mode (thermoelectric), rather than in the thermal-resistive mode (microbolometer). The resulting nano-engineered thermoelectric IR detector provides an increase in D* by an order of magnitude, while almost eliminating the need for post-processing electronics.

A new sensor system is needed for thermal imaging applications in fields such as lightweight platforms or micro-UAVs.

To address the above deficiencies in the prior art, a need exists for an LWIR sensor that operates uncooled like prior art microbolometers, but with higher sensitivity, faster response time, and multi-spectral/polarimetric capability, for instance, capable of reaching a BLIP (defined as D*) of at least better than 1.72×1010 cm-√Hz/W while operating at about 300K at a 30 Hz frame rate.

### BRIEF SUMMARY OF THE INVENTION

The thermoelectric detector comprises an infrared absorber pixel structure supported by two electrically connected beams made of thermoelectric materials such as polysilicon, polysilicon/germanium, bismuth-telluride, skutterrides, superlattice structures, nano-composites and other materials. One end of the thermoelectric beam connects to the infrared absorber pixel structure; the other end connects to the substrate. The detector comprises a microlens for collecting and focusing infrared radiation on the detector. Infrared radiation is incident on the infrared absorber pixel structure heats it, resulting in a temperature gradient along the length of the thermoelectric legs, and generating an electrical voltage proportional to the gradient. A low noise SIGe BiCMOS readout integrated circuit is coupled to the detector to provide a background limited detector having improved detectivity.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a prior art thermoelectric superlattice focal plane detector element suitable for use in the background limited focal plane array of the invention and as is disclosed in in U.S. Pat. No. 7,755,048, entitled, “Large Format Thermoelectric Infrared Detector and Method of Fabrication”, to Hsu.

FIG. 1a depicts an exploded view of the detector of FIG. 1.

FIG. 2 depicts a plan view of a plurality of the thermoelectric detectors of FIG. 1 in a focal plane array configuration.

FIG. 3 depicts the major elements of the background limited detector assembly of the invention.

FIG. 4 illustrates the contributions of the major elements of the invention which, in combination, achieve a D* BLIP for a microlens size of 25 um and 35 um diameter and a detector size of 10 um diameter.

FIG. 5 depicts a thermoelectric superlattice background limited focal plane array D* plotted against the invention's readout integrated circuit noise for the configuration shown in FIG. 1 comprising a microlens array, an RTI BiTe superlattice thin film with a ZT of 2.4, and a detector geometry substantially that as depicted in FIG. 1a.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

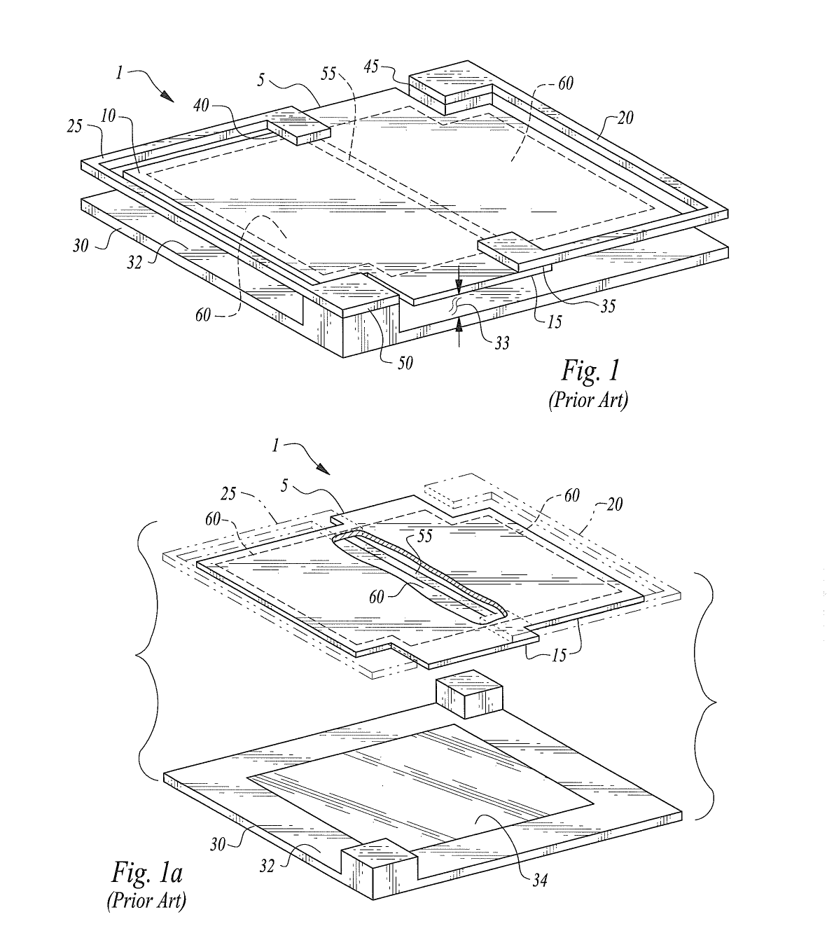

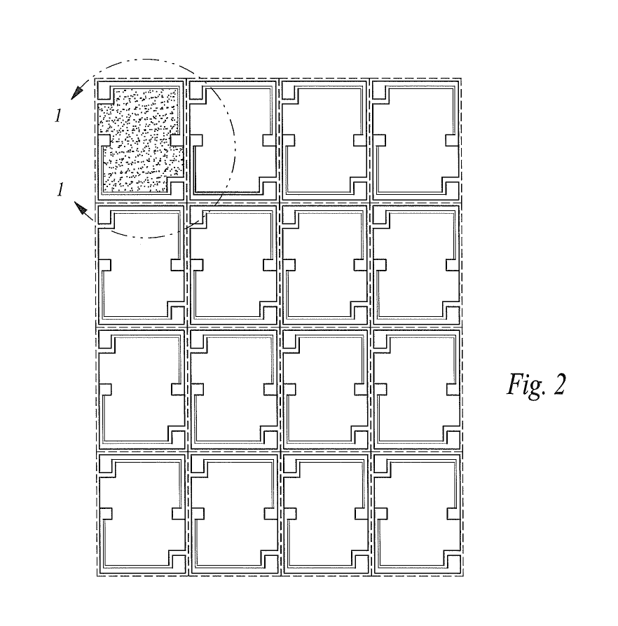

Turning now to the figures wherein like numerals define like elements among the several views, FIGS. 1 and 1a illustrate a prior art thermoelectric detector 1 suitable for use with the background limited detector assembly of the invention. FIG. 2 is a plan view of a plurality of detectors 1 in a focal plane array configuration.

Detector 1 comprises an infrared absorber pixel structure 5 comprising an upper major plate surface 10 and a lower major plate surface 15. Infrared absorber pixel structure 5 functions as an infrared radiation collector of IR energy incident upon upper major plate surface 10.

Infrared absorber pixel structure 5 is supported by at least two thermoelectric structures referred to as first thermoelectric structure 20 and second thermoelectric structure 25. First and second thermoelectric structures are preferably elongate, narrow beams or legs comprising one or more thermoelectric superlattice materials and may comprise bismuth-telluride, bismuth-antimony-telluride, polysilicon, polysilicon/germanium or equivalent materials.

Infrared absorber pixel structure 5 is suspended above a substrate 30 by means of the thermoelectric structures so as to define a hollow volume and an offset distance between infrared absorber pixel structure 5 and substrate 30 to provide thermal isolation of infrared absorber pixel structure 5 from the other detector elements. Substrate 30 comprises an upper major substrate surface 32.

As discussed further below, the hollow volume, referred to herein as an offset distance 33 herein, generally comprises a spaced-apart distance between the substantially parallel lower major plate surface 10 and upper major substrate surface 32. Offset distance 33 preferably comprises about 0.25 of the wavelength of a preselected optical wavelength so as to function as a resonant cavity to enhance the sensitivity of the detector 1. To further optimize the sensitivity of the detector, an IR reflective surface 34 is preferably disposed upon upper major substrate surface 32 for the reflection of IR radiated from infrared absorber pixel structure 5 back into infrared absorber pixel structure 5.

One end portion of first thermoelectric structure 20 is in connection with infrared absorber pixel structure 5 at first hot junction 35. One end portion of second thermoelectric structure 25 is in connection with plate structure 5 at second hot junction 40. The respective opposing ends of first and thermoelectric structures are in connection with substrate 30 at first cold junction 45 and second cold junction 50 respectively.

In the illustrated embodiment, first hot junction 35 and second hot junction 40 are in electrical connection by means of an electrically conductive structure 55, which may, for instance, comprise a metal trace or which may comprise an electrically conductive infrared absorber pixel structure 5 or other equivalent means.

As illustrated in FIGS. 1 and 1a, selected portions of first and second thermoelectric structures are preferably horizontally offset from infrared absorber pixel structure 5 for thermal isolation from infrared absorber pixel structure 5.

When incident IR heats infrared absorber pixel structure 5, detector 1 generates an output voltage that is proportional to the temperature difference between infrared absorber pixel structure 5 and substrate 30, outputting a voltage signal whose amplitude is proportional to the intensity of infrared radiation incident upon detector 1.

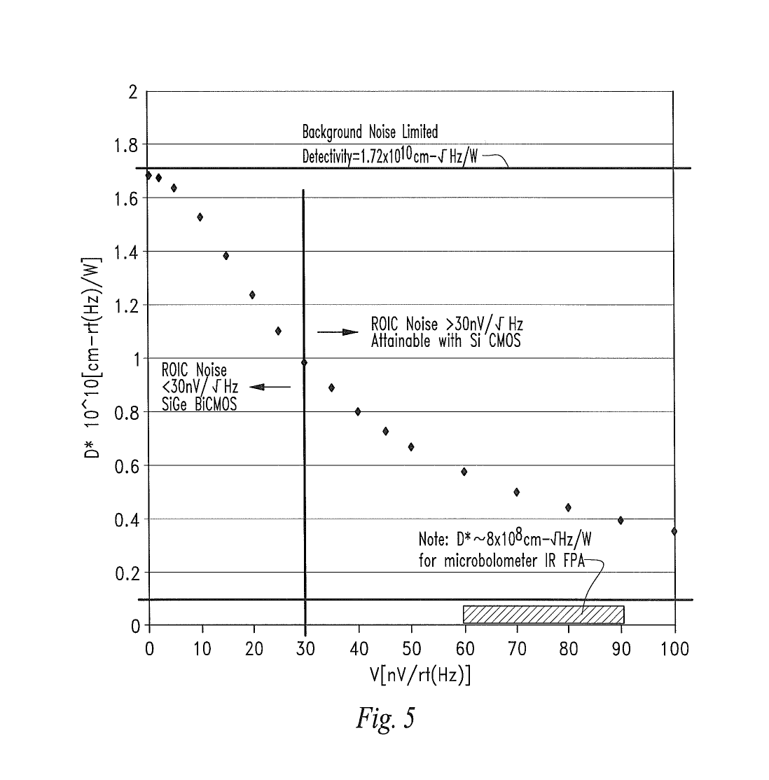

A reflector (not shown) is positioned under the absorber which forms a quarter-wave resonant cavity to maximize thermal energy absorption. The thermoelectric superlattice focal plane array of FIG. 5 is disclosed in U.S. Pat. No. 7,755,048, entitled, “Large Format Thermoelectric Infrared Detector and Method of Fabrication”, to Hsu.

To beneficially increase the IR sensitivity of detector 1, an IR absorbent material 60 such as platinum, an IR collecting nanostructure material, IR absorbing dyes or other equivalent means is preferably disposed upon upper major plate surface 10.

A cross-section of infrared absorber pixel structure 5 may comprise IR absorbent material 60 and electrically conductive structure 55 such as a conductive trace.

When detector 1 is disposed within a vacuum environment, a substantial portion of the IR absorbed by detector 1 passes from infrared absorber pixel structure 5 and through (rather than radiate from) the pair of thermoelectric structures, resulting in a temperature gradient across them. In turn, the thermoelectric structures generate a voltage that is approximately linearly proportional to the temperature gradient across them.

The above prior art thermoelectric detector 1 provides many beneficial features but is unable to achieve background limited infrared performance.

The disclosed invention herein overcomes this deficiency by means of elements in cooperation with the prior art detector to achieve the desired background limited infrared performance

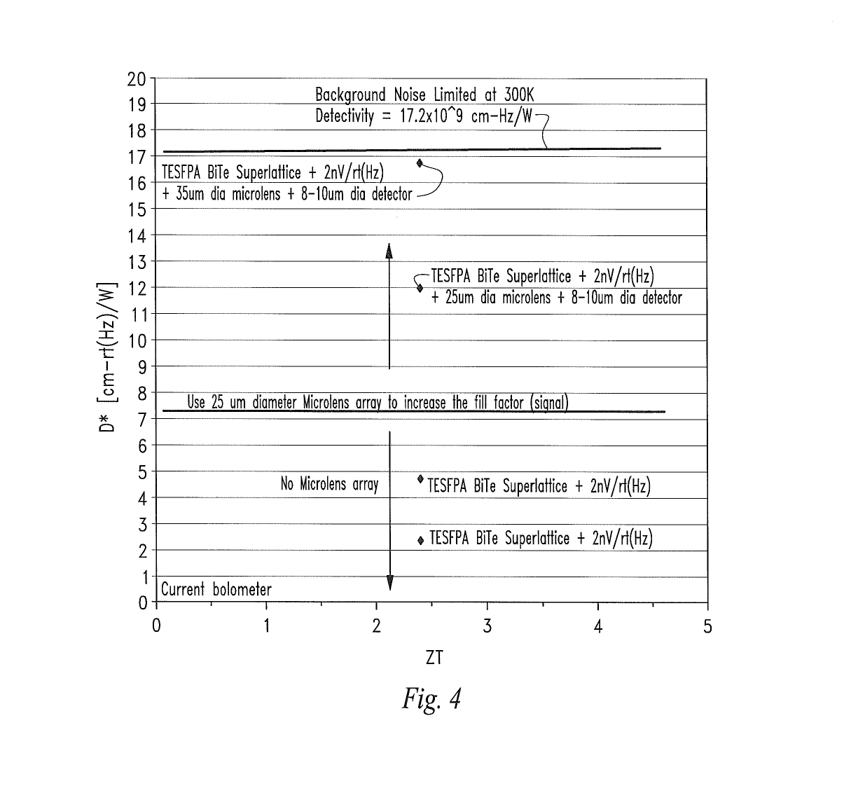

FIG. 4 illustrates the major elements of a preferred embodiment of a background limited FPA detector assembly 100 of the invention comprising a 25 micron microlens and an 8 micron detector 1 but the invention may be provided with microlens and detector geometries of any suitable dimensions.

As is depicted, detector assembly 100 generally comprising a microlens element 110, a SiGe BiCMOS readout integrated circuit 120 fabricated from a SiGe BiCMOS set of semiconductor processing steps in cooperation with a prior art thermoelectric FPA superlattice detector array 1.

As illustrated in the above discussed thermoelectric superlattice FPA sensor of FIGS. 1, 1a, 2 and 3, the detector element 1 may be comprised of an infrared absorber pixel structure supported by a pair of thermoelectric legs suspended over a vacuum gap, i.e., the detector element may be disposed within a vacuum structure or enclosure. Thermal radiation energy (IR) heats up the absorber and produces a delta temperature on the thermoelectric legs that generates a voltage proportional to the intensity of the incident radiation. A reflector element (not shown) may be positioned under the absorber structure which may define a quarter-wave resonant cavity to maximize thermal energy absorption. The absorber is suspended over a cavity to improve energy absorption, reduce thermal conduction loss and to maximize the temperature difference (delta) in the thermoelectric legs. The thermoelectric legs generate an electrical voltage as a result of the thermal delta due to the energy absorbed, thus providing a measure of the incident thermal radiation.

What is needed in addition to the benefits provided in the above prior art detector is means to provide background limited infrared performance, which is lacking in the embodiment of detector 1.

Advances in nano-engineered thermoelectric thin films and micro-optical devices provide new breakthroughs for fabrications of uncooled infrared detectors and can be used to achieve the desired background limited infrared performance from prior art detectors.

Although thermoelectric IR detectors have been available since early 1980's, it is only as recently as 1997 that high performance thermoelectric detector arrays were first reported by IPHT and by Jet Propulsion Laboratory. Examples of the early thermoelectric materials used in the past have included poly-silicon, silicon, germanium, and bismuth-telluride compounds. Further development of thermoelectric thin films in the past 10 years, and specifically nano-engineered superlattice thermoelectric materials, make a thermoelectric-based detector a suitable alternative to existing microbolometer technology.

A detector element in a thermoelectric superlattice focal plane array is unique in that the design may comprise a free-standing detector structure to achieve high thermal isolation for improved sensitivity. Certain prior art thermoelectric detectors required dielectric support layers under the thermoelectric legs, resulting in thermal bypass that degraded detector performance. The free-standing structure approach of the above discussed detector minimizes or eliminates thermal bypass problems. Additionally, recently developed superlattice thermoelectric thin-films have improved key material properties by nearly two orders of magnitude as compared to the properties of thermoelectric films used 10 years ago. The combined above free-standing detector structure combined with new nano-engineered material properties can enable thermoelectric detectors that surpass existing microbolometer performance.

Micro-electro-mechanical system (MEMS) processing technology may be used to fabricate the detector structure of the invention directly over lower cost CMOS readout IC wafers that are fabricated using well-established processing steps. The semiconductor post-processing steps of the device of the invention are compatible with the CMOS processes and can significantly reduce device fabrication costs.

The background limited detector assembly of the invention provides at least the following advantages over prior art microbolometer technologies as set forth below:
1. Lower temperature stabilization requirement: Thermoelectric superlattice focal plane arrays are about two orders of magnitude less sensitive to ambient temperature than microbolometer technology. Microbolometers measure absolute temperature in the detector while thermoelectric detectors measure the temperature difference between the detector and the substrate. This intrinsic differential sensing mechanism in a thermoelectric superlattice focal plane array dramatically reduces sensitivity to substrate temperature, yielding two orders of magnitude reduction in the temperature stabilization requirement as compared to microbolometers. For uncooled FPA applications, a low temperature stabilization requirement translates into significant reductions in calibration and image processing power.
2. Higher detector uniformity: The undesirably high temperature sensitivity of prior art microbolometers also contributes to high detector non-uniformity and low production yields. The differential sensing characteristics of thermoelectric superlattice focal plane arrays not only make the device substantially insensitive to temperature, but also make the sensor significantly less sensitive to material variations, resulting in greater uniformity and higher production yields.
3. Higher linearity: The output of the thermoelectric superlattice focal plane array of the invention is a self-generated voltage that responds substantially linearly to the intensity of incident radiation. Experience at Jet Propulsion Labs (JPL) during the development of space-qualified thermoelectric sensors has shown a linearity of less than about 1%. On the other hand, the outputs of prior art microbolometers are highly non-linear, requiring extensive calibration that consumes power and delays startup.
4. No 1/f Noise: Thermoelectric superlattice focal plane arrays detect IR wavelengths by converting “in-band” thermal energy into voltage through the thermoelectric effect. The resulting thermoelectric voltage can be measured with extremely low current, producing negligible 1/f noise. Conversely, the sensitivity of prior art microbolometers is typically about 3-15 times lower than theoretical models predicted and is limited primarily by 1/f noise and system noise. With negligible 1/f noise, the performance of thermoelectric superlattice focal plane arrays approaches the theoretical BLIP model and exceeds that of microbolometer.
5. High performance IR Focal Plane Array: Thermoelectric superlattice focal plane arrays have higher sensitivity and faster response time than microbolometer arrays. An order of magnitude improvement in D* values is achieved with LWIR detectors made with superlattice thin films.
6. Multispectral/polarimetric operation: Thermoelectric superlattice focal plane arrays, like all thermal detectors, are nearly wavelength independent. Multi-band simultaneous (mid and long wave IR) operation of the thermoelectric detector is possible by tuning an optical cavity to retain wavelengths of desired spectrum. Polarimetric capability may be achieved by placing polarization micro-structures directly above or proximal the detectors.
7. Higher sensor system reliability: The high linearity and wide dynamic range of thermoelectric superlattice focal plane arrays significantly reduces the complexity of real time calibration and image processing associated with microbolometer detectors.
8. Increased uniformity and manufacturing yield: The differential sensing of thermoelectric superlattice focal plane arrays provides effective common mode rejection, resulting in high uniformity in detector performance. Thermoelectric superlattice focal plane array detectors and the invention's CMOS readout circuits permit monolithic integration at the wafer fabrication level, maximizing manufacturing yield and lowering per unit FPA costs.
9. Low camera power consumption: The high linearity of thermoelectric superlattice focal plane arrays greatly simplifies calibration algorithms and reduces needed image processing power.

One of the main challenges in the design of thermoelectric detectors is the need for pixel-level amplification and integration. In contrast, prior art microbolometer readouts are generally performed using column-level amplification and integration while pixel level amplification and integration is already widely used in CMOS imagers.

A parametric study by the Applicant has determined that attaining background limited infrared performance is only attainable by optimizing and balancing four important detector parameters: 1) use of a high ZT nano-engineered superlattice material, 2) ultra-low noise readout integrated circuit design as discussed below, 3) a micro-lens array to maximize fill factor of the relatively large passive areas of the detectors in the array, and 4) a thermoelectric, superlattice detector design. Based on these parameters, the invention achieves a high performance uncooled LWIR background limited infrared performance or “BLIP”.

Referring back to FIGS. 1, 1a, 2, and 3, the illustrated preferred embodiment of the background limited focal plane array architecture 100 of the invention for achieving BLIP is depicted.

Detector 1 of the invention provides a base detector structure for achieving the aforementioned background limited IR performance. Applicant's modeling of the background limited focal plane array architecture determined that achieving BLIP is only achievable using an optimized combination of a superlattice thermoelectric film for a detector material, a SiGe Bi-CMOS process technology for providing an ultra-low noise readout integrated circuit, and a microlens for increased optical collection area (i.e., fill factor) upon the IR collection area of the detector elements in the array.

It is generally known that detector detectivity or D* is proportional to √Z. Current industry development efforts have been focused on attempting to raise this material figure of merit in an attempt to increase the D* value as the pixel pitch of FPAs scales down from 25 um to 17 um.

At low ZT, system noise is dominated by both the readout integrated circuit and the Johnson noises as found in virtually all existing state-of-the-art LWIR microbolometers. Under these conditions, D* is approximately proportional to √Z for low ZT materials such as VOx, a-Si, or even sputtered BiTe thin film.

However, the detectivity value D* becomes independent of Z at high ZT numbers when the readout integrated circuit and Johnson noise is reduced to levels where thermal fluctuation noise becomes the dominant noise source.

To achieve BLIP in a detector, the system noise must only be limited by the thermal fluctuation noise, i.e., the system must be limited only by thermal conduction of the detector legs and background radiation. This is a reason that an ultra-low noise readout integrated circuit is needed to achieve BLIP performance.

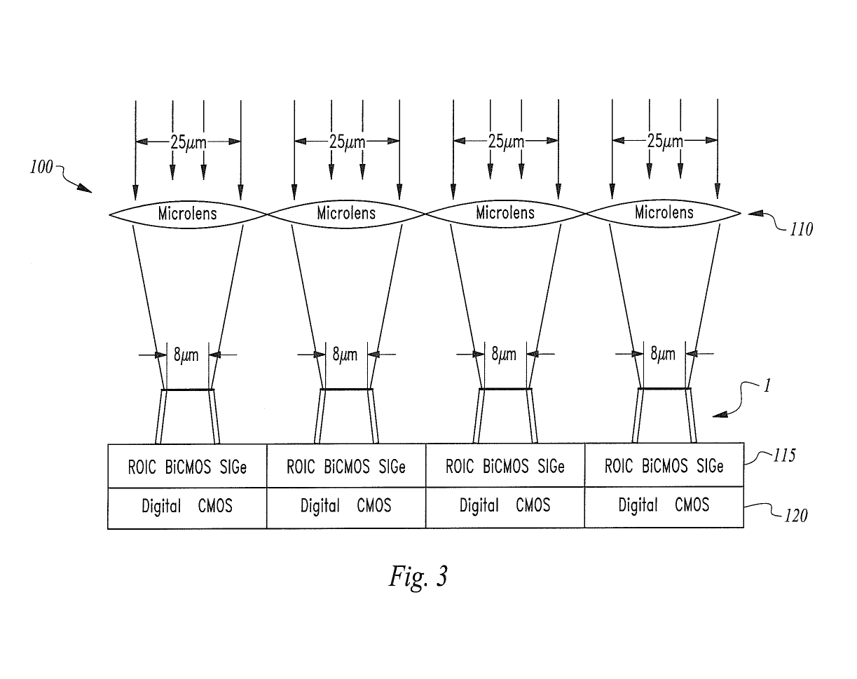

As seen in FIG. 4, major elements used to achieve an acceptable D* to attain BLIP are set forth. The illustration is for an exemplar microlens size of about 25 um and about 35 um in diameter and a detector size of about 10 um diameter. Improved D* is achieved with the cooperation of the four elements shown in FIG. 3, that is a microlens 110, a thermoelectric superlattice detector element 1, a BiCMOS SiGe readout integrated circuit 115 and digital CMOS circuitry 120, preferably configured as a three-dimensional stacked and interconnected microelectronic module using through-via technology. These innovations are beneficially integrated into a detector system driven by user needs and enable a lightweight, compact IR FPA that meets the goal of high sensitivity BLIP for operation in ambient environments.

FIG. 5 illustrates a graph of detectivity D*vs. readout integrated circuit noise from a model that assumes a relativity high ZT of about 2.4 (e.g., BiTe doped superlattice thin film), a Ge microlens diameter of about 35 um, and the detector design geometry depicted in FIGS. 1, 1a, 2 and 3. A D*(BLIP) can be achieved with a readout integrated circuit noise of about 2 to 5 nV/√Hz.

In the preferred embodiment of the invention, readout integrated circuit noise of about 2 nV/√Hz maximum is achievable at ambient temperatures. Applicant's earlier readout integrated circuit design studies showed that it is difficult to reduce the readout integrated circuit noise below 30 nV/√Hz using existing state-of-the-art mixed signal CMOS processing technology without compromising power consumption and enlarging the pixel area. The method and device of the invention permits the further reduction of readout integrated circuit noise to improve CMOS technology by another order of magnitude, i.e., from about 30 nV/√Hz to about 2 nV/√Hz.

The performance of prior art infrared readout integrated circuits is affected by at least three key parameters in the input analog amplifiers of the chip circuitry. The parameters are the amplifier gain, matching, and noise.

SiGe Bi-CMOS technology is commonly used for applications requiring high performance analog signal processing such as ultra-low noise or high gain linear amplification. The use of this technology beneficially retains the advantages of CMOS technology, i.e., low power and low cost. An advantage that Si CMOS has over the competing III-V technologies is the capability of high levels of integration. SiGe Hetero junction Bipolar Transistor (HBT) with high gain is well-suited for low impedance sensors such as the thermoelectric IR sensors of the invention because such sensors can drive the HBT by supplying the base current.

SiGe HBT can be successfully integrated with Si CMOS technology to realize SiGe BiCMOS technology. SiGe BiCMOS technology delivers ultra-low noise and high gain with very low signal amplification as well as baseband processing and control. Compared to mixed-signal Si CMOS technology, SiGe BiCMOS technology offers at least the following advantages: 1) a nano-engineered band gap, 2) a significant improvement in broadband and 1/f noises, 3) high density (smaller die size), and, 4) inherent radiation hardness due to its epitaxial base structure.

With respect to infrared readout integrated circuit applications, the following discussion considers the technical performance of SiGe BiCMOS versus mixed-signal CMOS technologies. Because both technologies have similar CMOS capabilities, the comparison between SiGe HBT versus FET is for analog functionality in the circuitry of the invention.

With CMOS processing, analog functions are generally designed with FET transistors. These features are somewhat difficult to design without operating at a high drain current and having a large device area due to gain, matching, and noise. SiGe HBT uses nano-engineered band gap to increase the current gain, (β) defined as JC/JB. This smaller base band gap increases the electron injection and, the HBT can achieve about five times higher (β) than a FET with (β) being independent of temperature. A typical (β) for SiGe is 350 while the same device in Si BJT is 67, for a VBE of 0.7V.

Since 1/f noise is proportional to

$$\frac{{I}_{C}^{2}}{β {fA}_{E}} ,$$

the higher the gain (β), the lower the 1/f noise of an amplifier. For IR imaging applications, each pixel must operate at a low current of a few uA and noise improvement is best achieved through a high amplifier gain, (β). This high gain permits a small thermoelectric detector signal to be amplified to a higher level before the addition of thermal and shot noises.
A SEM cross-section of a SiGe HBT has a SiGe layer about 50 nm thick. (John D. Cressler lecture on SiGe Technology: New Research Directions and Emerging Application Opportunities, IEEE Southeastern Michigan Chapter IV, Ann Arbor, Mich., May 2009).

SiGe HBT devices offer the advantage of excellent noise performance compared to FET devices. For infrared FPA applications, the operating requirement is about a 30 Hz to 60 Hz frame rate so the bandwidth is somewhat narrow. An acceptable method to limit the bandwidth to <60 Hz is to use a reset integrator. In this narrow bandwidth, the noise sources are primarily low frequency (1/f) noise and Johnson (white) noise.

In an HBT structure, 1/f noise is primarily generated in the emitter/base junction. In a FET, the 1/f noise is produced by the quality of the PN junction and the Si/SiO2 interface. CMOS scaling is used to reduce the SiO2 thickness, bringing the oxide interfaces closer to the active channel which results in worsening 1/f noise performance, as well as lower breakdown voltage.

The current generation of SiGe HBT has a clean Si/SiGe interface resulting in much lower 1/f noise. In fact, the measured 1/f noise is reported to be about 100 times smaller in a SiGe HBT than a Si FET. A low 1/f noise is significant because the signal amplifier does not require a chopper. This results in a simpler circuit, lower operating power, and a smaller unit cell readout integrated circuit size.

The other dominant noise source to be considered for infrared imaging applications is the thermal (Johnson) noise induced by the base resistance, RB. This noise voltage is \sqrt{4k_{B}TR_{B}}, where kB is the Boltzmann constant and T is the operating temperature. To reduce the Johnson noise, RB must be decreased as much as possible. The addition of a few monolayers of Ge makes it possible to heavily dope the base of a SiGe HBT without increasing the hole injection into the emitter, resulting in low RB, thus, lowering the thermal noise. That is, a low RB from a heavily Ge doped base is possible with band gap engineering without compromising the high gain (β).

The gain (β) can be increased by the decreasing the band gap, ΔEg, which is decoupled from the doping to a lower RB. Unlike Si CMOS, RB continues to improve with SiGe HBT scaling. The excellent DC performance of SiGe HBT makes ultra-low noise amplifiers feasible.

Additionally, VBE matching is an important feature in high performance analog IC design. For SiGe HBT, the matching of VBE is determined by the doping profiles across the emitter/base junction.

Because SiGe can scale in both the vertical and lateral dimensions, the doping levels can be increased with each technology improvement and matching depends more on the physical constraints of the HBT structure. In a CMOS FET, the equivalent parameter is Vt (threshold voltage) matching, which depends more on the uniformity of the doping levels and the lateral dimensions (L and W of the gate). The Vt matching is much less uniform from device-to-device. Therefore the matching in SiGe HBT is far superior compared to a CMOS FET.

Improved VBE matching reduces the offset in the performance of differential amplifiers which is a useful architecture for low noise readout integrated circuit design such as the differential chopper stabilized amplifiers used for the thermoelectric superlattice focal plane array readout integrated circuit architecture. With 4-6 times lower noise resistance, the SiGe HBT is easier to match to a low impedance thermoelectric detector. Reducing the amplifier offset is critical for low detector signals such as the thermoelectric IR sensors because with negligible offset, the chopper may be eliminated from the readout integrated circuit.

Current generation SiGe BiCMOS, based on a 0.13 um processing technology, is estimated to reduce the readout integrated circuit unit cell area by about 20-50% compared to mixed-signal CMOS technology for the same functionality. Estimated readout integrated circuit unit cell area is about 40 um×40 um for chopper stabilized differential amplifiers operating at 100 kHz to minimize 1/f noise using known readout integrated circuit design approaches.

Using SiGe BiCMOS, the readout integrated circuit footprint reduction permits a unit cell circuit area to fit directly under a single detector area of 25 um square. This avoids the need to use higher cost 3-D chip-stacking technology for the analog signal processing to improve signal integrity. With about a 100 times lower measured 1/f noise and proper matching, SiGe BiCMOS does not require a chopper, which is needed to convert the DC sensor signal to AC in order to eliminate offset and minimize 1/f noise, a feature that further reduces the unit cell readout integrated circuit area.

SiGe BiCMOS combines SiGe HBT with advanced Si CMOS to deliver high performance analog signal processing with all the power of Si CMOS integration. SiGe HBT is a technology that has performance improvement because, unlike CMOS, its performance improves with scaling.

In a preferred embodiment, the background limited detector assembly of the invention uses a 0.13 um SiGe BiCMOS process technology to provide an ultra-low noise readout integrated circuit for uncooled thermoelectric infrared imaging. Such an ultra-low noise readout integrated circuit is well-suited for thermoelectric IR detectors with low signal impedance. SiGe HBT achieves a readout integrated circuit noise of about 2 nV/√Hz in ambient operation with a small footprint that can fit in a unit cell pixel pitch of 25 um.

In the detector embodiment of FIGS. 1, 1a and 2, detector 1 may comprise an area of about 25 microns by about 25 microns. As is depicted, the IR absorber area is less than the pixel footprint area which may result in a smaller signal level. Assuming a pixel area of 25×25 microns, and an IR absorber area of about 19×24 microns, the collected signal is reduced to about 72.96% of the available signal. In order to increase the signal-to-noise area, the invention may comprise a microlens 110 to focus the incoming radiation over the pixel area to fall over the IR absorber area and increasing the signal level by about 27.04%.

A microlens 110 array may be placed over the detector array as illustrated in FIG. 3. The lens material is preferably selected to have good transmission in the thermal region of the spectrum (long wave infrared). The material used for the microlens may include germanium, zinc selenide and zinc sulfide. As is known in the optical and semiconductor processing arts, the process of manufacturing a microlens array is similar to the process of manufacturing integrated circuits and is well-suited for use and fabrication of the invention. A microlens array assembly for use in the invention may be manufactured by several companies such as Jenoptik Optical Systems, Inc.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A detector assembly comprising:
a thermoelectric detector comprising an infrared absorber pixel structure comprising a pixel surface area,
the infrared absorber pixel structure coupled to at least one thermoelectric structure at a hot junction,
a microlens element configured to collect and focus infrared energy of a predetermined spectrum upon the pixel surface area, and,
a read out integrated circuit.

2. The device of claim 1 wherein the read out integrated circuit comprises a SiGe BiCMOS readout integrated circuit fabricated in a set of SiGe BiCMOS semiconductor processing steps coupled to the at least one thermoelectric structure at a cold junction.

3. The device of claim 1 wherein the at least one thermoelectric structure comprises at least one of bismuth-telluride, antimony-telluride, lead telluride, polysilicon, germanium, skutterudite, a nano-composite material, and a super-lattice structure.

4. The device of claim 1 wherein the substrate comprises a reflector.

5. The device of claim 1 wherein the first distance is substantially a quarter-wavelength of a pre-selected detector wavelength, and wherein the infrared absorber pixel structure and the substrate are configured to act as a quarter-wave resonant cavity.

6. The device of claim 1 further comprising a vacuum enclosure coupled to the substrate to thereby enclose the infrared absorber pixel structure.

7. A focal plane array assembly comprising a plurality of detector elements wherein the plurality of detector elements each comprise:
a thermoelectric detector comprising an infrared absorber pixel structure comprising a pixel surface area,
the infrared absorber pixel structure coupled to at least one thermoelectric structure at a hot junction,
a microlens element configured to collect and focus infrared energy of a predetermined spectrum upon the pixel surface area, and,
a read out integrated circuit.

8. The assembly of claim 7 wherein the read out integrated circuit, comprises a SiGe BiCMOS readout integrated circuit fabricated in a set of SiGe BiCMOS semiconductor processing steps coupled to the at least one thermoelectric structure at a cold junction.

9. The device of claim 7 wherein the at least one thermoelectric structure comprises at least one of bismuth-telluride, antimony-telluride, lead telluride, polysilicon, germanium, skutterudite, a nano-composite material, and a super-lattice structure.

10. The device of claim 7 wherein the substrate comprises a reflector.

11. The device of claim 7 wherein the first distance is substantially a quarter-wavelength of a pre-selected detector wavelength, and wherein the infrared absorber pixel structure and the substrate are configured to act as a quarter-wave resonant cavity.

12. The device of claim 7 further comprising a vacuum enclosure coupled to the substrate to thereby enclose the infrared absorber pixel structure.
